(19) United States
(12) Patent Application Publication
(10) Pub. No.: US 2026/0186460 A1
(43) Pub. Date: Jul. 2, 2026

(54) ELECTRICAL APPARATUS AND METHOD

(71) Applicant: Festool GmbH, Wendlingen (DE)

(72) Inventors: Anika JANDT, Wendlingen (DE); Stefan BOZLER, Wendlingen (DE); Oliver DREXLER, Wendlingen (DE)

(21) Appl. No.: 19/436,908

(22) Filed: Dec. 30, 2025

(30) Foreign Application Priority Data
Dec. 30, 2024 (EP) 24223752.7

(51) Int. Cl. G05B 15/02; G08C 17/02; H02M 7/483

(52) U.S. Cl. CPC G05B 15/02; G08C 17/02; H02M 7/483

(57) ABSTRACT

An electrical apparatus designed as a power tool, vacuum cleaner, or exoskeleton, including: a drive device, a first electronic arrangement including a first computing unit for executing control software for controlling the drive device, a rechargeable battery for supplying power to at least the first computing unit, a switching device with a switch through which a first current path runs from the rechargeable battery to the first computing unit, and a second electronic arrangement via which the switching device can be controlled with a wake-up signal in order to switch the electrical apparatus from an off mode, in which the switch is open and the first computing unit is thus de-energized, into a communication mode in which the switch is closed and the first computing unit is thus supplied with power, so that the first computing unit is communicatively responsive.

### CROSS-REFERENCE

This application claims the benefit of European application EP24223752.7, filed Dec. 30, 2024, which is incorporated herein by reference.

The invention relates to an electrical apparatus designed as a power tool, vacuum cleaner, or exoskeleton, comprising: a drive device, a first electronic arrangement comprising a first computing unit for executing control software for controlling the drive device, a rechargeable battery for supplying power to at least the first computing unit, and a switching device with a switch through which a first current path runs from the rechargeable battery to the first computing unit.

### SUMMARY

It is an object of the invention to enable flexible and/or safe operation of the electrical apparatus in an energy-efficient manner.

The object is solved by an electrical apparatus as discussed herein. The electrical apparatus comprises a second electronic arrangement via which the switching device can be controlled with a wake-up signal in order to switch the electrical apparatus from an off mode, in which the switch is open and the first computing unit is thereby de-energized, to a communication mode, in which the switch is closed and the first computing unit is thereby supplied with power, so that the first computing unit is communicatively responsive.

The communication mode is, for example, a mode in which the electrical apparatus can be configured (in particular via an external device, for example a mobile device) and/or can exchange communication data, for example telemetry data, and/or can perform an update. In communication mode, the drive device is preferably not activated, in particular permanently de-energized. An update is, for example, a software update of the control software for controlling the drive device of the power tool and/or an update of parameters for operating the power tool.

Because the first computing unit is de-energized in the off mode and therefore cannot consume any power, it is possible to keep the energy consumption of the electrical apparatus very low in the off mode. Via the second electronic arrangement, the electrical apparatus nevertheless remains responsive (in particular from outside, for example via Bluetooth) and/or capable of switching to communication mode. In the off mode, the second electronic arrangement is expediently operated in an energy-saving mode in which the second electronic arrangement can continue to provide the wake-up signal. The second electronic arrangement is therefore expediently not de-energized in off mode. The second electronic arrangement is, for example, part of a rechargeable battery pack of the electrical apparatus. Alternatively, the second electronic arrangement may be assigned to an electrical apparatus main body, to which the rechargeable battery is removably attached.

Activation or energization of the drive device is preferably not necessary for entering communication mode. This enables safer operation, especially if the electrical apparatus is designed as a power tool. With a conventional power tool in particular, it may happen that a user who wants to configure the power tool (for example, using a mobile device held in one hand) and for this reason wants to cause the tool to leave the off mode, may press a power-on control element of the tool, which starts the drive of the tool (e.g., a saw blade) of the tool. This drive of the tool can be potentially dangerous, especially if the user is holding the mobile device in one of their hands when operating the power-on control element. The solution according to the invention allows the electrical apparatus to be woken up by means of the wake-up signal, so that the user does not need to activate the power-on control element (e.g., the drive mode operating element described below) to exit the off mode, and thus the drive device is not activated. It is not necessary for the user to be in physical contact with the electrical apparatus in order to exit the off mode.

Advantageous further developments are defined in the dependent claims.

The invention further relates to a method for operating the electrical apparatus, comprising the steps of: by means of the second electronic arrangement, controlling the switching device with the wake-up signal to switch the electrical apparatus from the off mode to the communication mode, and, in the communication mode, communicating with the first computing unit.

### BRIEF DESCRIPTION OF THE DRAWINGS

Further exemplary details and exemplary embodiments are explained below with reference to the figures.

FIG. 1 shows a schematic representation of a system with an electrical apparatus according to a first embodiment,

FIG. 2 shows a schematic representation of a system with an electrical apparatus according to a second embodiment,

FIG. 3 an arrangement of several different electrical apparatus main bodies, a rechargeable battery pack, and an external device,

FIG. 4 a circuit with a switching device and a first computing unit,

FIG. 5 a circuit diagram of an electrical apparatus with a rechargeable battery pack, and

FIG. 6 a circuit diagram of an electrical apparatus with two rechargeable battery packs.

### DETAILED DESCRIPTION

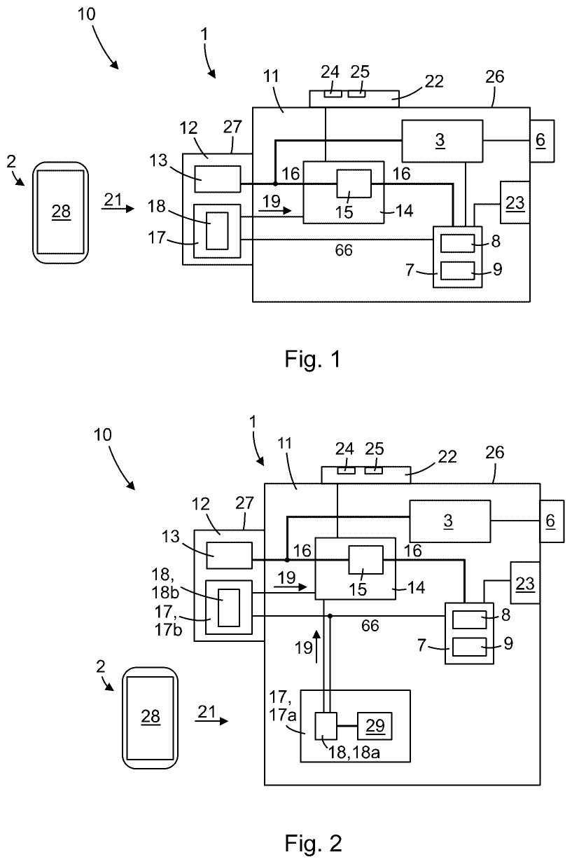

FIG. 1 shows a system 10 comprising an electrical apparatus 1 and an external device 2. The external device 2 is designed, for example, as a mobile device or as a central computer, for example as a cloud server. The mobile device is designed, for example, as a mobile phone, in particular as a smartphone, or as a tablet. The external device 2 is preferably a device separate from the electrical apparatus 1.

System 10 represents an exemplary application environment for the electrical apparatus 1. The electrical apparatus 1 can also be provided on its own, i.e., without external device 2.

The electrical apparatus 1 is preferably designed as a power tool, vacuum cleaner, or exoskeleton. In the design as a power tool, the electrical apparatus 1 can be implemented, for example, as a grinder, planer, plunge saw, hand-held circular saw, jigsaw, screwdriver, drill, or edge milling machine.

Preferably, the electrical apparatus 1 comprises an electrical apparatus main body 11 and a rechargeable battery pack 12 removably attached to the electrical apparatus main body 11. The electrical apparatus 1 expediently comprises a main body housing 26, which forms the outer housing of the electrical apparatus main body 11. The rechargeable battery pack 12 expediently comprises a rechargeable battery pack housing 27, which forms the outer housing of the rechargeable battery pack 12.

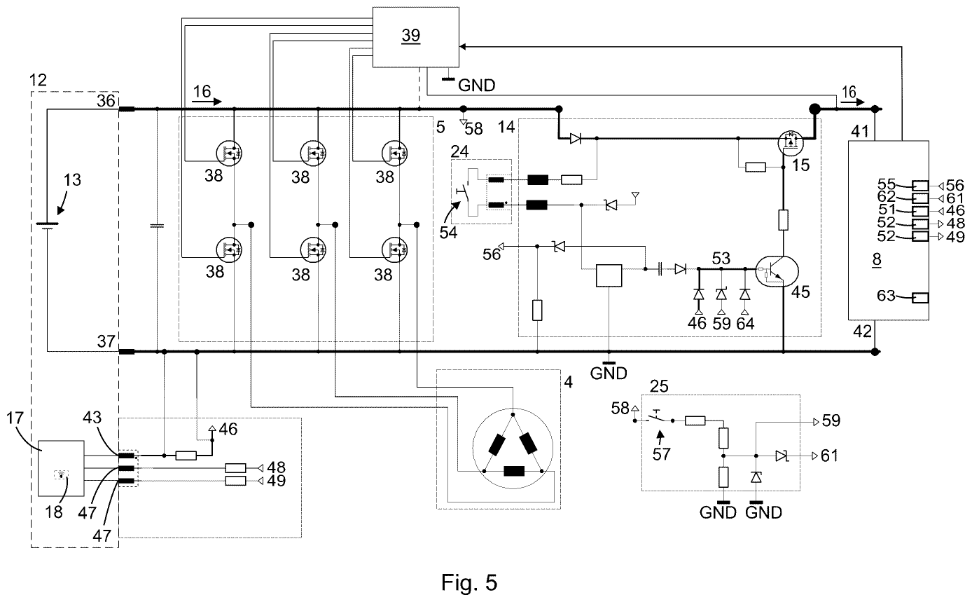

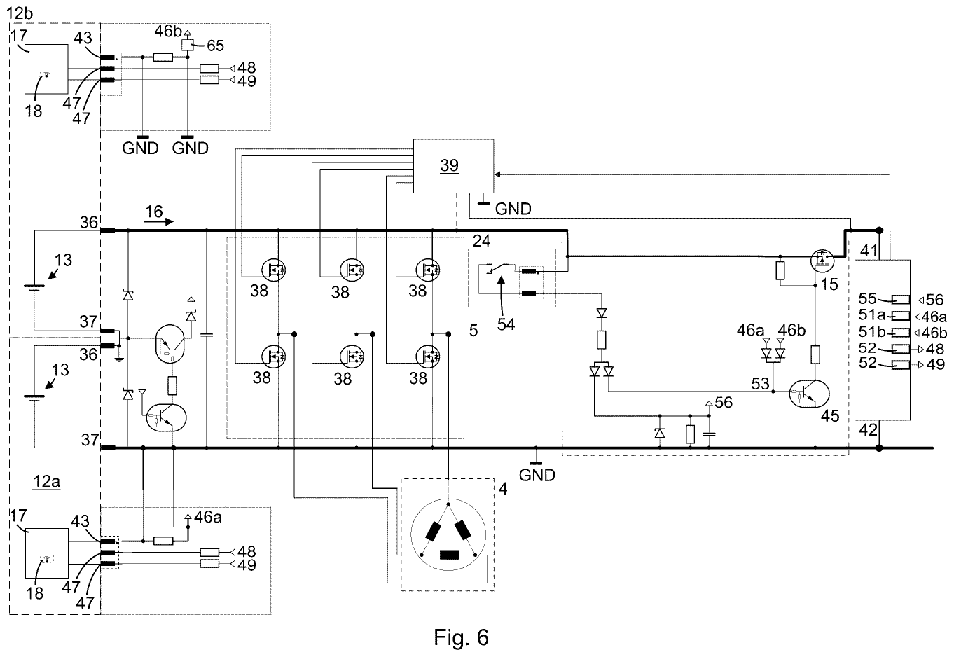

The electrical apparatus 1 comprises a drive device 3, which may comprise, for example, an electric motor 4 and/or power electronics 5 (see, for example, FIGS. 5 and 6). For example, the electrical apparatus 1 has a tool 6 that can be driven by the drive device 3. For example, the drive device 3 is part of the electrical apparatus main body 11 of the electrical apparatus. The tool 6 is expediently arranged on the electrical apparatus main body 11 of the electrical apparatus or can be part of the electrical apparatus main body 11 of the electrical apparatus.

The electrical apparatus 1 comprises a first electronic arrangement 7, which has a first computing unit 8. The first computing unit 8 is, for example, a first microcontroller. The first computing unit 8 is used to execute control software for controlling the drive device 3. For example, the first computing unit 8 uses the control software to generate control signals with which the first computing unit 8 controls the drive device 3, in particular the power electronics 5 (for example, via a driver unit 39). Optionally, the first electronic arrangement 7 has a memory 9. The first electronic arrangement 7 is, for example, part of the electrical apparatus main body 11.

The electrical apparatus 1 comprises a rechargeable battery 13 for supplying power to at least the first computing unit 8. Preferably, the rechargeable battery 13 also serves to supply power to the drive device 3. The rechargeable battery 13 is, for example, part of the rechargeable battery pack 12.

The electrical apparatus 1 preferably comprises an operating device 22 via which a user can switch on the electrical apparatus 1 in order to put the electrical apparatus 1 into a drive mode. According to one possible design, the user can switch on a lighting unit 23 of the electrical apparatus 1 via the operating device 22. The lighting unit 23 is designed, for example, as an integrated light and serves in particular to illuminate a working area of the electrical apparatus 1. The operating device 22 comprises, for example, a drive mode operating element 24, which can be actuated by the user to set the electrical apparatus 1 to drive mode, and/or a lighting unit operating element 25, which can be actuated by the user to switch on the lighting unit 23. Preferably, the drive mode operating element 24 and/or the lighting unit operating element 25 are arranged on the outside of the main body housing 26. According to an optional design, the lighting unit operating element 25 can be operated by the user to set the electrical apparatus 1 to a communication mode (explained in more detail below) (in particular, in addition to switching on the lighting unit 23). According to a further optional design, the lighting unit operating element 25 can be operated by the user to set the electrical apparatus 1 to drive mode (in particular in addition to switching on the lighting unit 23).

The electrical apparatus 1 comprises a switching device 14 with a switch 15. A first current path 16 runs from the rechargeable battery 13 to the first computing unit 8 via the switch 15. The switching device 14 is not part of the first computing unit 8 but is separate from it. The switching device 14, in particular the switch 15, is connected between the rechargeable battery 13 and the first computing unit 8. In this context, the term “switch” refers to a component with which an electrical connection can be selectively established or disconnected. When the switch is closed, the electrical connection is established, and when the switch is open, the electrical connection is disconnected. The switch 15 comprises, for example, a transistor and/or is designed as a transistor. The switching device 14 is, for example, part of the electrical apparatus main body 11.

The electrical apparatus 1 comprises a second electronic arrangement 17, which preferably comprises a wireless communication unit 18. In FIG. 1, the electrical apparatus 1 is designed according to a first embodiment, in which the second electronic arrangement 17 is preferably part of the rechargeable battery pack 12. The second electronic arrangement 17 is communicatively connected to the first computing unit 8 via a digital communication link 66, for example I²C.

The switching device 14 can be controlled via the second electronic arrangement 17 with a wake-up signal 19 in order to switch the electrical apparatus 1 from an off mode to a communication mode. The wake-up signal 19 is generated in particular by the second electronic arrangement 17, for example by the wireless communication unit 18. In the off mode, the switch 15 is open and the first computing unit 8 is thus de-energized. In the communication mode, the switch 15 is closed and the first computing unit 8 is thus supplied with power, so that the first computing unit 8 can be addressed for communication, for example by the second electronic arrangement 17. The electrical apparatus 1 can be switched to communication mode, in particular via the second electronic arrangement 17, without having to operate the operating device 22 for this purpose.

The wake-up signal 19 is preferably a wired signal. For example, the wake-up signal 19 is a voltage pulse, in particular a single voltage pulse, preferably a temporary change in voltage. The wake-up signal 19 is preferably an analog signal, in particular in the sense that the wake-up signal does not contain any digital data.

Preferably, the second electronic arrangement 17 is designed to output the wake-up signal in response to a wireless signal 21 received from external, in particular from the external device 2, via the wireless communication unit 18. Preferably, the wireless communication unit 18 is a Bluetooth communication unit (e.g., a BLE interface, where BLE stands for “Bluetooth Low Energy”) and the wireless signal is a Bluetooth signal. The wireless signal 21 is therefore transmitted in particular via Bluetooth from the external device 2 to the wireless communication unit 18. Alternatively or additionally, the wireless signal can be transmitted using a different wireless communication protocol, for example WLAN or NFC or mobile communications.

The wireless signal 21 can be triggered, for example, by the user making a corresponding input on the external device 2, for example by means of a touch display 28 and/or a button on the external device 2. For example, the user selects the electrical apparatus 1 in an app on the external device 2. In response to the user's input—for example, in response to the selection of the electrical apparatus 1—the external device 2 sends the wireless signal 21 to the wireless communication unit 18.

Preferably, the second electronic arrangement 17, in particular the wireless communication unit 18, stores an identifier of the electrical apparatus 1 and sends it to the external device 2, in particular the mobile device, for example upon request from the external device 2 and/or as broadcasting. Based on the received identifier, the external device 2 can indicate to the user (e.g., by means of a corresponding graphic display or text) what type of device the electrical apparatus 1 is, in particular before the user selects the electrical apparatus 1 on the external device 2, in particular in the app, and/or causes the wireless signal 21 and/or the wake-up signal 19 to be sent. In this way, the user can be made aware of which electrical apparatus they are connecting to (via the external device 2) before this electrical apparatus is woken up or put into communication mode. The identifier is stored in the second electronic arrangement 17 automatically, for example, when the rechargeable battery pack 12 is attached to the electrical apparatus 1. Furthermore, the identifier of the electrical apparatus 1 is deleted from the second electronic arrangement 17 when the rechargeable battery pack 12 is removed from the electrical apparatus 1. Alternatively, the identifier of the electrical apparatus 1 may no longer be transmitted by the rechargeable battery pack 12 or is transmitted as inactive when or after the rechargeable battery pack 12 is/has been removed from the electrical apparatus 1.

Optionally, the wireless signal 21 is automatically sent from the external device 2 to the wireless communication unit 18, for example in response to the wireless communication unit 18 being within a transmission range of the external device 2 and/or a wireless communication connection being established between the external device 2 and the wireless communication unit 18 and/or according to a timer that runs periodically in particular.

Preferably, the second electronic arrangement 17 controls the switching device 14 with the wake-up signal 19 in response to the wireless signal 21, in particular the Bluetooth signal.

According to a possible variant, the second electronic arrangement 17 can be designed to trigger the control of the switching device 14 with the wake-up signal 21 independently - in this case, the wake-up signal 21 is provided in particular without the need to receive a wireless signal for this purpose. In this variant, the second electronic arrangement 17 does not necessarily have to have a wireless communication unit. The independent triggering of the provision of the wake-up signal 21 can be effected, for example, by a timer running in the second electronic arrangement 17.

The communication mode will be discussed in more detail below.

According to one possible design, the communication mode is a configuration mode. The first computing unit 8 can be configured in the communication mode, for example according to configuration information provided from external, in particular by the external device 2. The configuration information is provided in particular to the first computing unit 8, for example via the second electronic arrangement 17. For example, in the communication mode, a configuration of the lighting unit 23, a setting of processing parameters, for example a cutting depth, a saw blade diameter and/or a saw blade angle, and/or a setting of a direction of travel of the tool 6 can be carried out, in particular in accordance with the configuration information. The configuration information can, for example, be specified by the user using the external device 2. For example, the configuration serves to specify one or more default values for one or more processing parameters. The electrical apparatus 1 is expediently designed to use the set default values as the processing parameters when switched on. The processing parameters include, for example, the aforementioned cutting depth, saw blade diameter, saw blade angle, or direction of travel of the tool (e.g., a screwdriver bit or drill bit). When configuring the lighting unit 23, for example, a luminous intensity and/or a afterglow duration of the lighting unit 23 is set. If the electrical apparatus 1 is designed as an exoskeleton, the strength of a support force and/or an angle at which the support force is provided can be configured in communication mode, for example.

Optionally, the first computing unit 8 is designed to perform, in communication mode, one or more of the following: exchange communication data, write communication data to a memory (e.g., memory 9), and/or perform an update, e.g., a firmware update. The communication data includes, in particular, telemetry data and/or operating data of the electrical apparatus 1. In communication mode, the communication data is transmitted, for example, from the first computing unit 8 via the wireless communication unit 18 to the external device 2, in particular the mobile device and/or the cloud server. Furthermore, in communication mode, the communication data can be transmitted from the external device 2 via the wireless communication unit 18 to the first computing unit 8.

Expediently, the electrical apparatus has a drive mode in which the drive device 3 is activated and provides a drive force and/or drive movement. The drive mode is, for example, the normal active mode of the electrical apparatus 1, in which the drive device 3 runs and provides a drive (for example, of the tool 6). For example, in the drive mode, the drive device sets the tool 6 in a processing motion, which serves in particular to remove material from a workpiece. In the drive mode, the switch 15 is closed so that the first computing unit 8 is supplied with power. In the drive mode, the first computing unit 8 (using its control software) controls the power electronics 5 (e.g., via a driver unit 39) in such a way that the power electronics 5 supplies the electric motor 4 with power from the rechargeable battery 13. For example, the electrical apparatus 1 can be switched from off mode to drive mode (in particular exclusively) by actuating the operating device 22, in particular the drive mode operating element 24.

Preferably, in communication mode, the drive device 3 is not activated and no drive force and/or no drive movement, in particular of the tool 6, is provided. The drive device 3 is not activated or cannot be activated in communication mode, in particular because the power supply to the drive device 3 is blocked. The state in which the drive device 3 is blocked is also referred to as the blocking state (or as locked state). For example, the first computing unit 8 is designed to control the drive device 3 (in particular the power electronics 5) in communication mode, in particular in the blocking state, in such a way that the drive device 3 (in particular the electric motor 4) remains de-energized. Expediently, in the communication mode, in particular in the blocking state, controls of the drive device 3 (in particular the power electronics 5) which lead to the drive device 3 (in particular the electric motor 4) being supplied with current are blocked, in particular by means of software. The drive device 3 is thus switched to a non-functional state. For example, in the communication mode, in particular in the blocking state, the driver unit 39 cannot be controlled in order to operate the motor 4 by means of the power electronics 5. Alternatively or additionally, in the communication mode, in particular in the blocking state, the drive device 3 can be rendered inoperable by interrupting the power supply to the drive device 3, for example by means of a switch.

Preferably, the electrical apparatus 1 can be designed so that the electrical apparatus 1 cannot be switched to drive mode via the operating device 22 in communication mode, in particular in the blocking state. For example, the operating device 22 is locked in communication mode, in particular in the blocking state, so that the electrical apparatus 1 cannot be switched to drive mode in the communication mode via the operating device 22, in particular via the drive mode operating element 24. The lock is implemented, for example, by the operating device 22 (e.g., the drive mode operating element 24) being switched to a non-functional mode in the communication mode, in particular in the blocking state, for example by a corresponding software configuration of the first computing unit 8. Alternatively, the electrical apparatus 1 can be switched to drive mode in communication mode via the operating device 22 (e.g., the drive mode operating element 24).

The blocking state is, in particular, a state in which the electrical apparatus 1 cannot switch to drive mode, even if there is a request to switch to drive mode, for example in the first computing unit 8. Expediently, the electrical apparatus 1 further has an enabling state. The enabling state is, in particular, a state in which the electrical apparatus 1 can switch to the drive mode, in particular in response to a request to switch to the drive mode, for example in the first computing unit 8.

According to a possible configuration, the electrical apparatus 1 assumes the blocking state by default when the first computing unit 8 is switched on (by supplying power via the first switch 15). If the first computing unit 8 detects that it has been switched on via the wake-up signal 19, it remains in the blocking state. If the first computing unit 8 determines that it has been switched on via the drive mode operating element 24, it changes from the blocking state to the enabling state, in which the drive device 3 is not locked.

According to an alternative design, the electrical apparatus 1 assumes the enabling state by default when the first computing unit 8 is switched on (by supplying power via the first switch 15). In the enabling state, the drive device 3 is not locked. If the first computing unit 8 detects that it has been switched on via the wake-up signal 19, it changes from the enabling state to the blocking state. If the first computing unit 8 detects that it has been switched on via the drive mode operating element 24, it remains in the enabling state.

Optionally, the first computing unit 8 distinguishes in communication mode between first actions that can (potentially) impair the operation of the electrical apparatus 1 and second actions that do not impair the operation of the electrical apparatus 1. An example of a first action is a software update, and an example of a second action is reading information from the first computing unit 8. Preferably, in communication mode, the first computing unit 8 is in the blocking state by default and maintains the blocking state when a first action is requested. When a second action is requested, the first computing unit 8 can switch to the enabling state (in particular for the duration of the second action or during the duration of the second action). According to an alternative embodiment, in communication mode, the first computing unit 8 is in the enabling state by default and maintains the enabling state when a second action is requested. When a first action is requested, the first computing unit 8 switches to the blocking state (in particular for the duration of the first action).

Preferably, the electrical apparatus 1 is designed to switch from the communication mode to the off mode in response to a timer expiring and/or in response to a shutdown signal. The timer is provided, for example, by the first computing unit 8. The timer is reset, for example, with each communication of the first computing unit 8. The shutdown signal is provided, for example, by the external device 2 or the second electronic arrangement 17.

In FIG. 2, the electrical apparatus 1 is designed according to a second embodiment, in which the second electronic arrangement 17 is part of the electrical apparatus main body 11. Except for the differences discussed, the second embodiment corresponds to the first embodiment, so that the explanations relating to the first embodiment also apply to the second embodiment.

In the second embodiment, the electrical apparatus main body 11 comprises the second electronic arrangement 17. This second electronic arrangement 17 arranged in the electrical apparatus main body 11 shall also be referred to as the main body electronic arrangement 17a. The wireless communication unit 18 of the main body electronic arrangement 17a shall also be referred to as the main body wireless communication unit 18a. The main body electronic arrangement 17a may, for example, be designed as a plug-in unit, for example a retrofittable plug-in unit, or may be permanently installed in the electrical apparatus main body 11.

The second electronic arrangement 17 has its own power supply 29, separate from the rechargeable battery 13, to provide the energy required for the wake-up signal 19 and/or for receiving the wireless signal 21. The power supply 29 is, in particular, an electrical energy storage device, for example, another rechargeable battery or a battery, for example, a button cell. The power supply 29 serves to supply the wireless communication unit 18 with power so that it can output the wake-up signal 19 and/or receive the wireless signal 21. In particular, the power supply 29 does not serve to supply the drive device 3 with power.

Optionally, in the second embodiment, a second electronic arrangement 17 may also be present in the rechargeable battery pack 12, as in the first embodiment. In this case, this second electronic arrangement 17 may be referred to as rechargeable battery pack electronic arrangement 17b, and its wireless communication unit 18 as rechargeable battery pack wireless communication unit 18b.

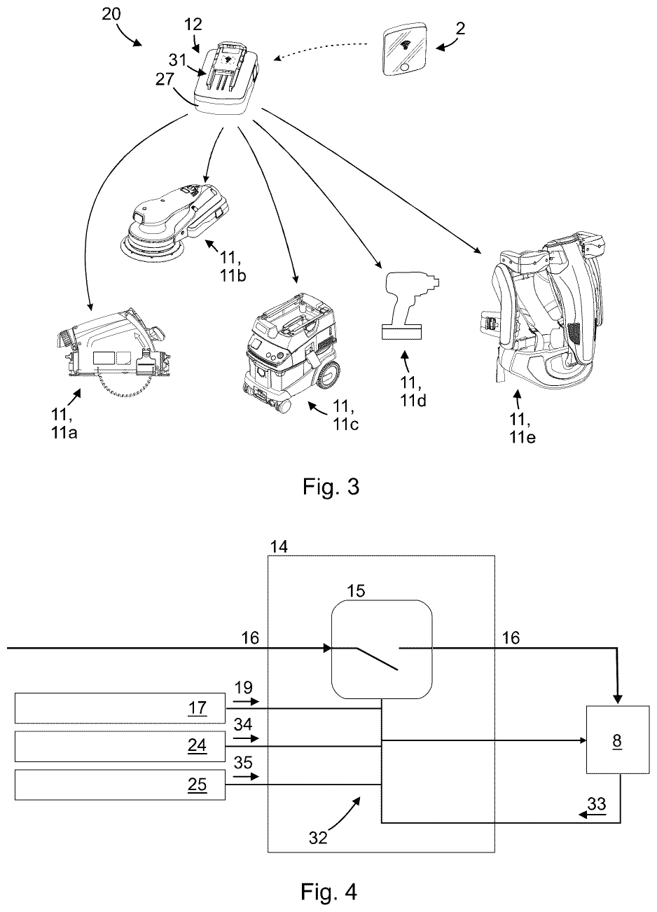

FIG. 3 shows an arrangement 20 comprising several different electrical apparatus main bodies 11, the rechargeable battery pack 12, and the external device 2. The electrical apparatus main bodies 11 include, for example, a saw main body 11a, a grinder main body 11b, a vacuum cleaner main body 11c, a screwdriver/drill main body 11d, and/or an exoskeleton main body 11e. Each of the electrical apparatus main bodies 11a, 11b, 11c, 11d, 11e shown represents a possible exemplary design of the electrical apparatus main body 11. The rechargeable battery pack 12 is compatible with each of the electrical apparatus main bodies 11 and can be attached to each of the electrical apparatus main bodies 11 in order to supply power to the respective electrical apparatus main body 11 and to enable the provision of the wake-up signal 19 to the respective electrical apparatus main body 11.

The rechargeable battery pack 12 has an electromechanical interface 31 with which the rechargeable battery pack 12 can be removably attached (in particular without tools) to a respective electrical apparatus 1. The electromechanical interface 31 has, for example, an engagement structure that can be brought into mechanical engagement with a correspondingly designed engagement structure on the respective electrical apparatus 1 in order to attach the rechargeable battery pack 12 to the electrical apparatus 1. The electromechanical interface 31 also has several electrical contacts, which serve in particular to supply the electrical apparatus 1 with power, to provide the wake-up signal 19, and/or to communicate with the first computing unit 8.

The saw main body 11a serves (together with the rechargeable battery pack 12) to form a sawing device, for example a hand-held sawing device, such as a plunge saw, or a semi-stationary sawing device, such as a chop saw or a table saw. The tool 6 driven by the drive device 3 is a saw blade in this case.

The grinder main body 11b serves (together with the rechargeable battery pack 12) to form a grinding device, for example a random orbital sander, edge sander or cut-off grinder. The tool 6 here is a grinding tool, for example a sanding disc.

The vacuum cleaner main body 11c serves (together with the rechargeable battery pack 12) to form a vacuum cleaner device, which is used in particular to extract dust generated when working with a power tool. In the suction main body 11c, the drive device 3 serves in particular to generate a vacuum and/or air flow, for example by means of a blower.

The screwdriver/drill main body 11d serves (together with the rechargeable battery pack 12) to form a screwdriver/drill device, for example a cordless screwdriver or a cordless drill. The tool 6 here is a screwdriver bit or a drill bit.

The exoskeleton main body 11e serves (together with the rechargeable battery pack 12) to form an exoskeleton that can be worn on the human body in particular. The exoskeleton preferably serves to provide a supporting force for a body part, for example an arm, a leg, or the back. The drive device 3 serves, for example, to provide the supporting force. The drive device 3 may comprise, for example, an electric motor (in particular in an electric version of the drive device) and/or a compressed air compressor (in particular in a pneumatic version of the exoskeleton).

FIG. 4 shows an exemplary design of the switching device 14, which here has a connection circuit 32. The representation of the connection circuit 32 is purely schematic. The connection circuit 32 transmits the wake-up signal 19 from the second electronic arrangement 17 to the switch 15. Preferably, the connection circuit 32 also transmits the wake-up signal 19 to the first computing unit 8. Based on the received wake-up signal 19, the first computing unit 8 can determine that it has been powered up and thus switched on via the switch 15 due to the wake-up signal 19 provided, and can specifically enter communication mode (instead of, for example, drive mode) in response to this determination. It is expedient for the wake-up signal 19 to be provided long enough so that it is still present at the first computing unit 8 - and can therefore be received and evaluated by the first computing unit 8 - after the first computing unit 8 has been powered up and thus switched on via the switch 15 due to the wake-up signal 19 provided.

The switching device 14 can also be controlled by at least one closing signal that is different from the wake-up signal 19, in particular a closing signal that does not originate from the second electronic arrangement 17, in order to close the switch 15 and/or keep it closed. Examples of closing signals are a drive mode signal 34 originating from the drive mode operating element 24, a lighting mode signal 35 originating from the lighting unit operating element 25, and/or a hold signal 33 originating from the first computing unit 8 itself. The wake-up signal 19 also represents a closing signal. The drive mode signal 34 serves to set the electrical apparatus 1 to drive mode. The lighting mode signal 35 serves to set the electrical apparatus to a lighting mode in which the lighting unit 23 is switched on and emits light and the drive device 3 is preferably switched off. The hold signal 33 is used in particular to maintain the closed state of the switch 15—and thus the power supply provided via the switch 15—beyond the end of the provision of the wake-up signal 19 (or one of the other closing signals). For example, the first computing unit 8 is designed to provide the hold signal 33 itself in response to being supplied with power by the provision of the wake-up signal 19 (or one of the other closing signals) and thereby switched on, in order to cause the first computing unit 8 to continue to be supplied with power and remain switched on.

The connection circuit 32 is expediently designed to provide a logical OR link between the closing signals (with regard to the switch 15), so that each individual closing signal is capable of closing or keeping the switch 15 closed on its own.

The first computing unit 8 is preferably designed to set the electrical apparatus 1 to one of several possible modes, depending on which signal (i.e., which closing signal) was used to control the switching device 14 to close the switch 15. In particular, the first computing unit 8 sets the electrical apparatus 1 to the mode (i.e., for example, the drive mode, communication mode, or lighting mode) that is assigned to the closing signal with which the switch 15 was closed. The connection circuit 32 is expediently designed to feed each of the closing signals to the first computing unit 8 so that the first computing unit 8 can determine which closing signal closed the switch 15. In particular, for this purpose, the connection circuit 32 feeds the closing signals on different signal paths to respective separate contacts of the first computing unit 8.

Preferably, the first computing unit 8 is designed to assume the enabling state, in which the drive device 3 is not blocked, in response to the closing signal that closed the switch 15 not originating from external (i.e., in particular, not being the wake-up signal). In particular, the first computing unit 8 only assumes the enabling state in this case.

According to one possible design, the connection circuit 32 does not route one of the closing signals (for example, the wake-up signal 19) to the first computing unit 8. The first computing unit 8 can conclude that this closing signal has closed the switch 15 if the first computing unit 8 is switched on and none of the other closing signals are present.

FIG. 5 shows an exemplary (simplified) circuit diagram of the electrical apparatus 1. The ground potential is marked with the abbreviation “GND”.

The rechargeable battery pack 12 comprises a first power supply contact 36 and a second power supply contact 37, between which the rechargeable battery voltage of the rechargeable battery 13, for example 18 V, is provided. The second power supply contact 37 is connected to the ground potential “GND” in this example. The power electronics 5 are connected between the power supply contacts 36, 37 and preferably comprises an inverter, for example a three-phase bridge circuit. The power electronics 5 has three branches connected in parallel to each other, each comprising two transistors 38. The transistors 38 are controlled by the first computing unit 8 in accordance with the control software (for example, by means of a driver unit 39) in order to supply power to the electric motor 4 and thereby drive it. The driver unit 39 can also be regarded as part of the power electronics 5 (or the drive device 3). The electric motor 4 is designed, for example, as a brushless DC motor.

The first current path 16 runs from the first power supply contact 36 via the switch 15, which is designed as a first transistor, to a first power supply connection 41 of the first computing unit 8. Via its second power supply connection 42, the first computing unit 8 is connected to the second power supply contact 37 and/or is at ground potential.

The second electronic arrangement 17 has a wake-up contact 43 at which the second electronic arrangement 17 outputs the wake-up signal 19. A wake-up signal path, for example a wake-up current path, runs from the wake-up contact 43 to a circuit node 53, via which the first switch 15 can be selectively closed or opened. For example, a control connection of a second transistor 45 of the switching device 14 is connected to the circuit node 53. The second transistor 45 controls the first transistor 15 in order to selectively close or open it, so that the first transistor 15 selectively establishes or interrupts the first current path 16. For example, the second transistor 45 controls the control connection of the first transistor 15.

Optionally, a signal path, for example a current path, also runs from the wake-up contact 43 to a wake-up contact 51 of the first computing unit 8. For the sake of clarity, the electrical lines are not shown in their entirety—the connection points marked with reference number 46 are electrically connected directly to each other.

For example, the second electronic arrangement 17 has two communication contacts 47 that are electrically connected to two communication contacts 52 of the first computing unit 8 to form the digital communication link 66 via which the second electronic arrangement 17 can communicate with the first computing unit 8. The two connection points marked with reference number 48 are directly connected to each other electrically, and the two connection points marked with reference number 49 are directly connected to each other electrically. Communication takes place in particular in accordance with a digital communication protocol, for example in accordance with I²C. The first computing unit 8 can communicate externally via the second electronic arrangement 17, for example with the external device 2, exemplarily the mobile device and/or the cloud server, in particular for exchanging the communication data and/or the configuration information.

The power supply contacts 36, 37, the wake-up contact 43, and/or the communication contacts 47 are expediently part of the electromechanical interface 31 of the rechargeable battery pack 12.

The drive mode operating element 24 comprises a drive mode switch 54, the actuation of which transmits the drive mode signal 34 via a drive mode signal path to the circuit node 53 in order to cause the first switch 15 to be closed. The drive mode switch 54 is expediently connected between the first power supply contact 36 and the circuit node 53. Optionally, a signal path is provided through which the drive mode signal 34 is further transmitted to a drive mode contact 55 of the first computing unit 8. This signal path runs, for example, via the connection points marked with reference numeral 56, which are directly connected to each other electrically.

The lighting unit operating element 25 comprises a lighting unit switch 57, the actuation of which transmits the lighting mode signal 35 via a lighting mode signal path to the circuit node 53 in order to cause the first switch 15 to be closed. The lighting unit switch 57 is expediently connected between the first power supply contact 36 and the circuit node 53. The connection point 58 shown is connected to the first power supply contact 36. The connection points 59 are directly connected to each other. Optionally, a signal path is provided through which the lighting mode signal 35 is further transmitted to a lighting mode contact 62 of the first computing unit 8. This signal path runs, for example, via the connection points marked with reference numeral 61, which are electrically connected directly to each other.

Preferably, the first computing unit 8 further comprises a hold contact 63 for outputting the hold signal 33 to the circuit node 53 via a hold signal path. The hold contact 63 is connected, for example, to the connection point 64.

The second electronic arrangement 17 outputs the wake-up signal 19 at the wake-up contact 43 for a period of time which is, for example, at least 5 ms, at least 10 ms, or at least 15 ms, and preferably a maximum of 20 ms or a maximum of 30 ms. To provide the wake-up signal 19, the second electronic arrangement 17 changes, in particular increases, the electrical potential of the wake-up contact 43 during the time period. This changes, for example increases, the electrical potential at the circuit node 53 so that the first switch 15 is closed and thereby the first computing unit 8 is supplied with power from the rechargeable battery 13 and thus switched on. In response to the first computing unit 8 being switched on, it outputs the hold signal 33 at its hold contact 63, so that the electrical potential at the circuit node 53 remains changed, in particular increased, after the time period has elapsed and the wake-up signal 19 is no longer provided. The first computing unit 8 recognizes from the wake-up signal 19 received at the wake-up contact 51 that the switch 15 has been closed by the wake-up signal 19 and accordingly enters communication mode. According to an alternative design (in which the wake-up signal 19 is not fed to the first computing unit 8), the first computing unit 8 recognizes that it has not received a closing signal and therefore that the switch 15 has been closed by the wake-up signal 19, and accordingly enters communication mode.

FIG. 6 shows a (simplified) circuit diagram of the electrical apparatus 1 according to a variant in which the electrical apparatus 1 has two rechargeable battery packs 12 - a first rechargeable battery pack 12a and a second rechargeable battery pack 12b. With regard to features already shown in FIG. 5, reference is made to the corresponding explanations for FIG. 5, which apply mutatis mutandis to FIG. 6. Features shown in FIG. 5 and not shown in FIG. 6 (e.g., the hold contact 63 and hold signal path, or the lighting unit operating element 25 and associated features) may nevertheless also be present in the present variant of the electrical apparatus 1 (with two rechargeable battery packs 12).

Each of the rechargeable battery packs 12a, 12b is designed like the rechargeable battery pack 12 already described. The two rechargeable battery packs 12a, 12b are connected in series, for example, to provide the electrical apparatus 1 with double the rechargeable battery voltage, i.e., 36 V, for example. Each of the rechargeable battery packs 12a, 12b has a respective wake-up contact 43 for outputting a respective wake-up signal 19. The signal paths originating from the two wake-up contacts 43 are brought together at the circuit node 53. Each rechargeable battery pack 12a, 12b can independently close the first switch 15 with its respective wake-up signal 19. Optionally, each wake-up contact 43 also has a respective separate signal path to a respective wake-up contact 51a, 51b of the first computing unit 8. The signal paths run via the electrically directly connected connection points 46a and via the electrically directly connected connection points 46b.

In the wake-up signal path for the wake-up signal output by the second rechargeable battery pack 12b, a voltage divider 65 is expediently provided to reduce the electrical voltage of the wake-up signal 19 (relative to ground potential). In the wake-up signal path for the wake-up signal output by the first rechargeable battery pack 12a, there is advantageously no corresponding voltage divider. Due to the series connection of the two batteries 13, the electrical potential of the wake-up contact 43 of the second rechargeable battery pack 12b is higher (in particular by one rechargeable battery voltage) than the electrical potential of the wake-up contact 43 of the first rechargeable battery pack 12a. In order to ensure that the wake-up signals of the two rechargeable battery packs 12a, 12b still have approximately the same electrical potential when they arrive at the circuit node 53, the voltage divider 65 is provided for the second rechargeable battery pack.

The following describes a method for operating the electrical apparatus 1. Expediently, the electrical apparatus 1 is initially in the off mode.

The method comprises the steps of:
Selecting the electrical apparatus 1 in an app on an external device 2, in particular the mobile device, in particular by a user,
in response to the selection of the electrical apparatus 1, sending the wireless signal 21, in particular as a Bluetooth signal, from the external device 2, in particular the mobile device, to the second electronic arrangement 17, and
in response to the wireless signal 21, the second electronic arrangement 17 controlling the switching device 14 with the wake-up signal 19 in order to switch the electrical apparatus from the off mode to the communication mode.

In communication mode, communication with the first computing unit 8 takes place expediently. For example, the first computing unit 8 receives configuration information from the external device 2 and performs a configuration in accordance with the configuration information.

Optionally, the electrical apparatus 1 automatically returns to the off mode, for example, after a corresponding timer has expired. In particular, the electrical apparatus 1 automatically enters the off mode when a predetermined period of time has elapsed since the last communication of the first computing unit 8. The expiration of this predetermined period of time is expediently determined by means of the timer. To enter the off mode, the electrical apparatus 1 terminates the power supply to the first computing unit 8. For example, to enter the off mode, the first computing unit 8 terminates the provision of the hold signal 33, so that the first switch 15 is opened and the power supply to the first computing unit 8 is terminated.

Expediently, during the entire process, i.e., from the initial state in which the electrical apparatus 1 is in off mode until communication mode is entered (or until off mode is returned to), no direct operation of the electrical apparatus 1 (in the sense of actuating a control element of the electrical apparatus 1) by the user is required and preferably does not take place.

Expediently, the drive device 3 remains deactivated throughout the entire process, i.e., from the initial state in which the electrical apparatus 1 is in the off mode until the communication mode is entered (or until the apparatus returns to the off mode). In particular, the drive device 3 is not activated during the entire process.

Optionally, before sending the wake-up signal 19, a check is made to see whether the first computing unit 8 is already powered up. If this is the case, the wake-up signal 19 does not need to be sent.

Optionally, before sending the wake-up signal 19, a check is made as to whether the electrical apparatus 1 is in drive mode. If this is the case, the wake-up signal 19 is not sent. Preferably, it is indicated to the user of the external device 2, in particular the mobile device, that the electrical apparatus 1 is in operation. Alternatively or additionally, it may be provided that the communication mode is not entered as a result, or that a passive communication mode is entered in which data can be read out from the electrical apparatus 1.

Error! Text mark not defined.

1. An electrical apparatus designed as a power tool, vacuum cleaner, or exoskeleton, comprising:
a drive device,
a first electronic arrangement comprising a first computing unit configured to execute control software for controlling the drive device,
a rechargeable battery for supplying power to at least the first computing unit,
a switching device with a switch through which a first current path runs from the rechargeable battery to the first computing unit,
a second electronic arrangement for controlling the switching device with a wake-up signal in order to switch the electrical apparatus from an off mode, in which the switch is open and the first computing unit is thus de-energized, into a communication mode, in which the switch is closed and the first computing unit is thereby supplied with power, so that the first computing unit is communicatively responsive.

2. The electrical apparatus according to claim 1, wherein the second electronic arrangement comprises a wireless communication unit and is configured to output the wake-up signal in response to a wireless signal received via the wireless communication unit from an external source.

3. The electrical apparatus according to claim 2, wherein the wireless communication unit is a Bluetooth communication unit and the wireless signal is a Bluetooth signal.

4. The electrical apparatus according to claim 1, wherein the second electronic arrangement is configured to autonomously trigger the control of the switching device by means of the wake-up signal.

5. The electrical apparatus according to claim 1, wherein the first computing unit is configurable in the communication mode.

6. The electrical apparatus according to claim 5, wherein, in the communication mode, the first computing unit is configurable for configuring a lighting unit and/or for setting processing parameters and/or for setting a cutting depth, a saw blade diameter, a saw blade angle, and/or a direction of travel of a tool of the electrical apparatus.

7. The electrical apparatus according to claim 1, comprising an electrical apparatus main body and a rechargeable battery pack removably attached to the electrical apparatus main body, wherein the electrical apparatus main body comprises the drive device and the first electronic arrangement, and the rechargeable battery pack comprises the rechargeable battery and the second electronic arrangement.

8. The electrical apparatus according to claim 1, comprising an electrical apparatus main body and a rechargeable battery pack removably attached to the electrical apparatus main body, wherein the electrical apparatus main body comprises the drive device, the first electronic arrangement, and the second electronic arrangement, and the rechargeable battery pack comprises the rechargeable battery.

9. The electrical apparatus according to claim 1, wherein the electrical apparatus has a drive mode in which the drive device is activated and provides a drive force and/or drive movement, wherein in communication mode the drive device is not activated and does not or cannot provide a drive force and/or drive movement.

10. The electrical apparatus according to claim 9, wherein, in communication mode, the power supply to the drive device is blocked, so that the drive device cannot be activated in the communication mode.

11. The electrical apparatus according to claim 9, comprising an operating device via which a user can switch on the electrical apparatus in order to set the electrical apparatus to the drive mode, or via which the user can switch on a lighting unit of the electrical apparatus, wherein the electrical apparatus can be set to communication mode via the second electronic arrangement without having to operate the operating device.

12. The electrical apparatus according to claim 1, wherein the rechargeable battery serves to supply power to the drive device.

13. The electrical apparatus according to claim 1, wherein the first computing unit is configured to perform at least one of the following in communication mode: exchange communication data, write communication data to a memory and/or to perform an update.

14. The electrical apparatus according to claim 13, wherein the communication data comprises telemetry data and/or operating data of the electrical apparatus.

15. The electrical apparatus according to claim 1, wherein the switching device can also be controlled by at least one closing signal other than the wake-up signal in order to close the switch, and the first computing unit is configured to set the electrical apparatus to different modes depending on which signal was used to control the switching device to close the switch.

16. The electrical apparatus according to claim 15, wherein the closing signal does not originate from the second electronic arrangement.

17. The electrical apparatus according to claim 1, wherein the second electronic arrangement has its own power supply separate from the rechargeable battery in order to provide the energy required for the wake-up signal and/or for receiving a wireless signal.

18. The electrical apparatus according to claim 1, wherein the electrical apparatus is configured to switch from communication mode to off mode in response to a timer expiring and/or in response to a switch-off signal.

19. A method for operating an electrical apparatus according to claim 1, comprising the steps:
by means of the second electronic arrangement, controlling the switching device with the wake-up signal in order to switch the electrical apparatus from the off mode to the communication mode,
in communication mode, communicating with the first computing unit.

20. The method according to claim 19, further comprising the steps of:
selecting the electrical apparatus in an app on an external device,
in response to the selection of the electrical apparatus, sending a wireless signal to the second electronic arrangement, wherein the second electronic arrangement controls the switching device with the wake-up signal in response to the wireless signal.
Error! Bookmark not defined.
